(19) United States
(12) Patent Application Publication
(10) Pub. No.: US 2010/0232870 A1
(43) Pub. Date: Sep. 16, 2010

(54) SELECTIVELY REINFORCED PISTON PIN

(75) Inventor: Stephen Z. Golya, Long Beach, CA (US)

Correspondence Address: THOMPSON HINE L.L.P.;Intellectual Property Group, P.O. BOX 8801, DAYTON, OH, 45401-8801, US

(73) Assignee: DELAWARE CAPITAL FORMATION, INC., Wilmington, DE (US)

(21) Appl. No.: 12/402,714

(22) Filed: Mar. 12, 2009

(51) Int. Cl. F16J 1/16; B21K 1/44

(52) U.S. Cl. 403/150; 29/888.05

(57) ABSTRACT

A pin assembly including a piston pin configured to couple a piston to a connecting rod. The piston pin includes a pin body having an inner cavity and a stiffening rib positioned to resist forces applied to the pin body by a connecting rod. The assembly further includes a pair of ovalarity-resisting ribs and a pair of shear-resisting ribs. Each shear-resisting rib is axially positioned between one of the ovalarity-resisting ribs and the stiffening rib and positioned to resist shear forces applied to the pin body by a connecting rod and a piston. The assembly further includes at least one insert received in the inner cavity, wherein the at least one insert provides at least one of the stiffening rib, or at least one of the ovalarity-resisting ribs, or at least one of the shear-resisting ribs.

The present invention relates to piston pin, and more particularly, to a piston pin that is reinforced at selected locations to improve the strength of the pin and its resistance to external forces.

### BACKGROUND

Piston pins, also known as gudgeon pins or wrist pins, are used to couple a piston to an associated connecting rod. Thus, the piston pin serves as a critical link so that the reciprocating motion of the piston is transferred to the connecting rod. It is desirable to reduce the weight of a piston pin to decrease the inertial mass of the piston assembly and allow more efficient operation thereof. However, the piston pin must also be sufficiently strong to resist bending moments, shear loads and ovalization forces.

### SUMMARY

In one embodiment, the invention is a piston pin which is generally hollow, to reduce weight, but is reinforced at strategic positions to provide sufficient stiffness. More particularly, in one embodiment the invention is a pin assembly including a piston pin configured to couple a piston to a connecting rod. The piston pin includes a pin body having an inner cavity and a stiffening rib positioned to resist forces applied to the pin body by a connecting rod. The assembly further includes a pair of ovalarity-resisting ribs and a pair of shear-resisting ribs. Each shear-resisting rib is axially positioned between one of the ovalarity-resisting ribs and the stiffening rib and positioned to resist shear forces applied to the pin body by a connecting rod and a piston. The assembly further includes at least one insert received in the inner cavity, wherein the at least one insert provides at least one of the stiffening rib, or at least one of the ovalarity-resisting ribs, or at least one of the shear-resisting ribs.

### BRIEF DESCRIPTION OF THE DRAWINGS

FIG. 1 is a front perspective view of a piston assembly;

FIG. 2 is a side cross section of a piston assembly;

FIG. 3 is a detail view of the upper portion of the assembly of FIG. 2;

FIG. 4 is a perspective cross section of the pin of FIGS. 2 and 3;

FIG. 5 is a perspective cross section of an alternate embodiment of the pin;

FIG. 6 is a perspective cross section of another alternate embodiment of the pin; and

FIG. 7 is a perspective cross section of yet another alternate embodiment of the pin.

### DETAILED DESCRIPTION

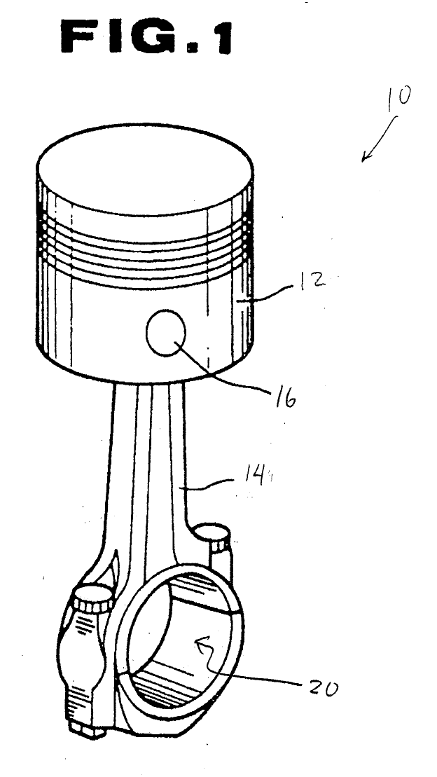

As shown in FIGS. 1-3, a piston assembly 10 may include a piston 12, a connecting rod 14 and a piston pin 16 connecting the piston 12 to the connecting rod 14. The piston 12 is typically positioned in a piston bore of an engine block (not shown) of an internal combustion engine or the like used in an automotive vehicle or for other purposes. The piston 12 is moved in a reciprocating manner in its piston bore during operation of the engine. The reciprocating motion of the piston 12 is transmitted to the connecting rod 14 by the piston pin 16. The connecting rod 14 is, in turn, coupled to a crank shaft (not shown) which provides the output of the engine.

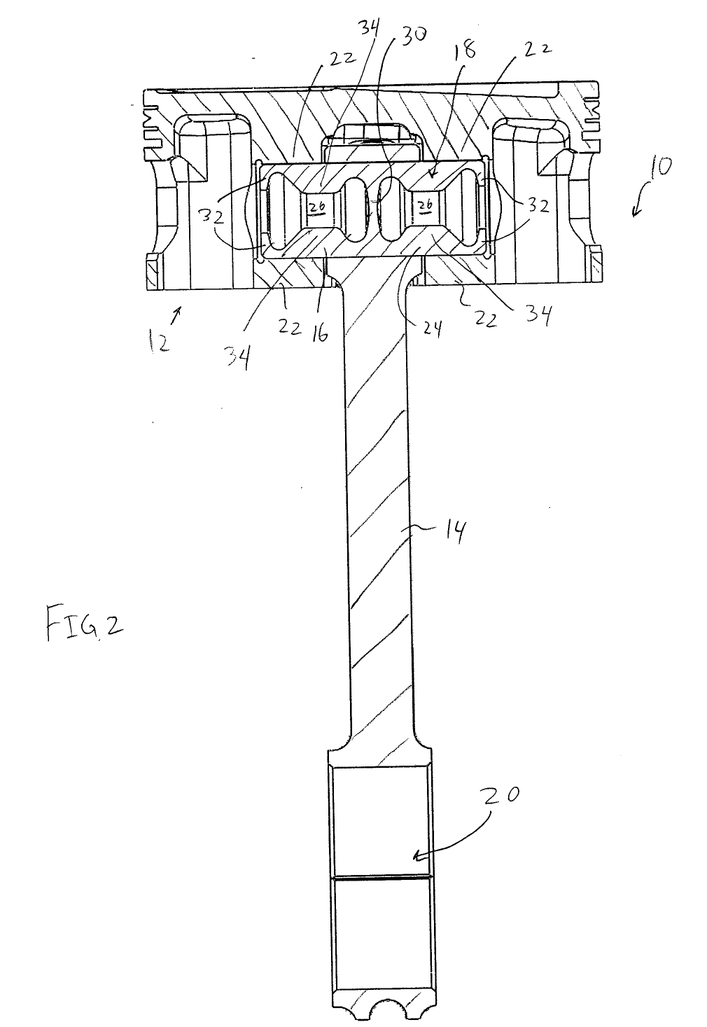

As best shown in FIG. 2, the connecting rod 14 includes an upper opening 18 and a lower opening 20, both of which are generally circular in cross section in the illustrated embodiment. The upper opening 18 of the connecting rod 14 receives the pin 16 therein, and the lower opening 20 receives the crank shaft therein. The piston 12 includes a pair of opposed pin towers 22, each of which has a opening therein (the openings are circular in the illustrated embodiment). The outer distal or axial ends of the pin 16 are received in the pin towers 22.

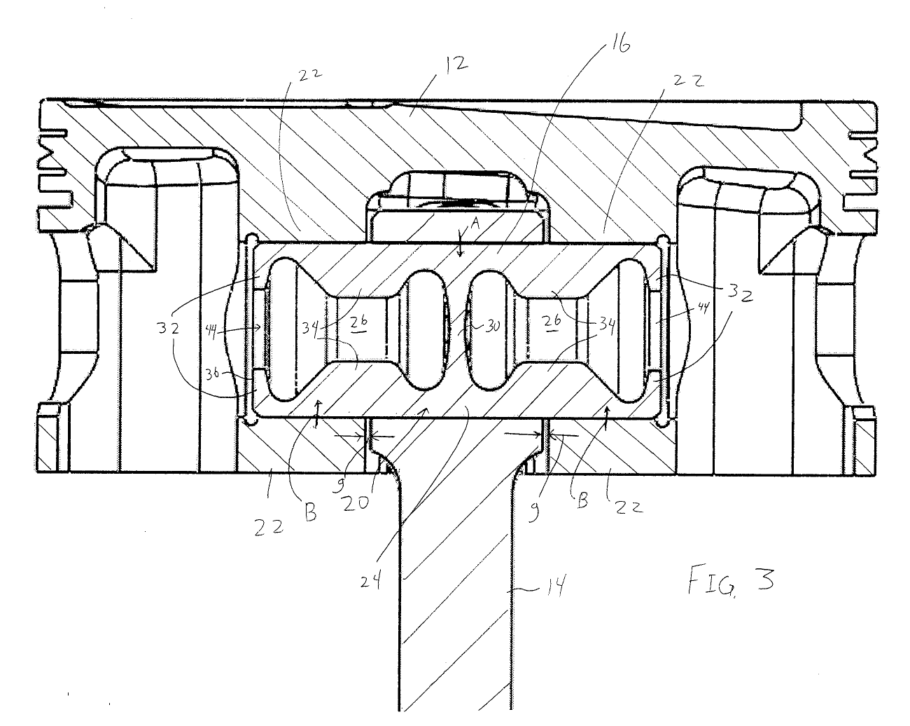

During operation of the piston/engine, various forces are applied to the piston pin 16. For example, as shown in FIG. 3, at the end of an upward stroke of the piston (but before reaching top dead center), the upper end of the connecting rod 14 may impose a downward force A upon the top surface of the piston pin 16 due to deceleration of the connecting rod 14. This force applied by the connecting rod 14 can cause bending moments and/or reduce the roundness of the pin 16. At the same time that the connecting rod 14 is supplying the downward force A, the pin towers 22 may apply upward forces B to the underside of the pin 16 due to the momentum/deceleration of the piston 12. These forces B applied by the pin towers 22 also impart bending moments and/or tend to reduce the roundness of the pin 16.

Moreover, the forces A and B combine to apply shear forces to the pin 16. With reference to FIG. 3, it can be seen that, force A applied by the connecting rod 14 is opposite in direction to the forces B applied by the pin towers 22, thereby causes shear forces to be applied to the pin 16 at or adjacent to the points where the connecting rod 14 is adjacent to the pin towers 22 (i.e., adjacent to the gaps g between the pin towers 22 and the connecting rod 14. Of course, various other forces can be applied to the pin 16 during movement of the piston 12/operation of the engine, including the application of forces in a like manner to forces described above but in differing orientations and magnitudes, i.e., at the end of a downward stroke/start of an upward stroke, or at top dead center or bottom dead center positions.

In order to reduce weight of the piston assembly 10, the pin 16 may have a pin body 24 that is generally hollow having an inner cavity 26. The inner cavity 26 may be continuous or broken into various sub-cavities. The pin body 24 may be generally cylindrical and the inner cavity 26 may be generally cylindrical, although other configurations may be implemented.

In order to increase the strength of the pin 16 at strategically selected positions, the pin 16 may be reinforced or thickened with stiffening members or ribs. In particular, the pin 16 may include a stiffening rib 30 to resist loading forces A applied to the pin 16 by the connecting rod 14. In the illustrated embodiment, the stiffening rib 30 is located at the axial center of the pin 16. However, the position of the stiffening rib 30 may be varied, as desired, to match the position of the connecting rod 14 and/or accommodate other forces or design considerations.

In the illustrated embodiment, the stiffening rib 30 is a complete rib or web which extends to the radial center of the pin 16 and is generally circular in side view/cross section. This configuration provides increased strength to the rib 30/pin 16. However, if desired, the stiffening rib 30 may be only a partial rib which does not extend to the radial center of the pin 16 and is instead generally disk-shaped or annular in cross section, having a central opening. Such a partial rib configuration reduces weight, and aids in manufacturing in some cases.

The pin 16 may include a pair of ovalarity-resisting ribs 32 positioned at or adjacent to opposite axial ends of the pin 16. The ovalarity-resisting ribs 32 help to maintain the cylindrical configuration of the pin 16. In many cases, it may be important to maintain a circular cross section of the pin 16 and resist any forces that tend to ovalize the pin 16. In particular, if the pin 16 were to deform and become more oval in cross section, contact between the pin 16 and pin towers 22 (and connecting rod 14) become localized, resulting in increased pressure and forces, and causing galling and other undesirable results.

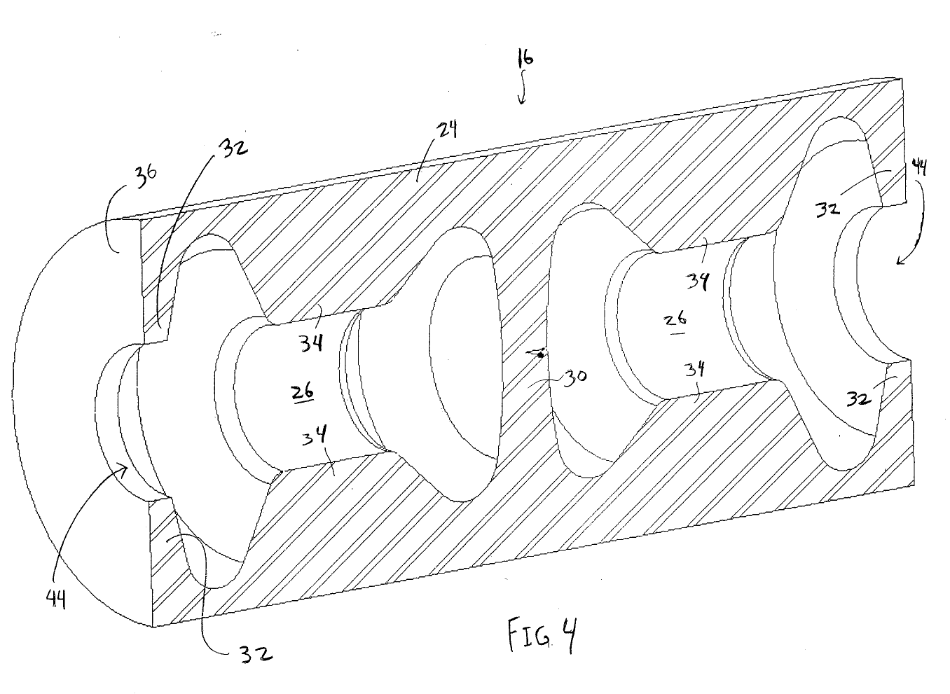

In the illustrated embodiment, the ovalarity-resisting ribs 32 are positioned at the axial ends of the pin 16 such that the ovalarity-resisting ribs 32 provide flush axial end surfaces 36 of the pin 16. However, if desired, the ovalarity-resisting ribs 32 may be moved axially inwardly (i.e., towards the stiffening rib) and away from the axial end positions as shown in FIGS. 2-4.

The pin 16 may include a pair of shear-resisting ribs 34 located on opposite sides of the stiffening rib 30, with each shear-resisting rib 34 being axially positioned between one of the ovalarity-resisting ribs 32 and the stiffening rib 30. The shear-resisting ribs 34 may each be positioned to resist maximum shear forces applied to the pin 16 by the connecting rod 14 and the piston 12. Accordingly, in the illustrated embodiment, the shear-resisting ribs 34 are located at and/or span the axial gap g between the connecting rod 14 and pin towers 22. The shear-resisting ribs 34 may be positioned along various axial locations, but may be, in general, positioned to best resist the shear forces. The shear-resisting ribs 34 may be thicker than the stiffening rib 30 and/or ovalarity-resisting ribs 32 since the shear forces applied to the pin 16 may be the highest forces, and/or may be the most important forces to be resisted to avoid failure of the pin 16.

In one embodiment, the stiffening rib 30 is positioned at the axial center of the pin 16, each ovalarity-resisting ribs 32 is positioned at or adjacent an axial end of the pin 16, and each shear-resisting rib 34 is positioned at about the midpoint between the stiffening rib 30 and the adjacent ovalarity resisting rib 32 (i.e., at about the ¼ and ¾ positions along the length of the pin 16). In the embodiment shown in FIGS. 2-4, the shear-resisting ribs 34 and ovalarity-resisting ribs 32 are partial ribs that do not extend to the radial center of the pin 16. However, if desired, the shear-resisting ribs 34 and/or ovalarity-resisting ribs 32 may be complete ribs which extend to the radial center of the pin 16 in the manner of the stiffening rib 30 described above. All of the ribs 30, 32, 34 may help to reduce ovalization and bending of the pin 16, which can cause cracking or failure, and/or help to resist shear forces.

Each of the ribs 30, 32, 34 may simply take the form of increased stiffness and/or thickness at the associated position on the pin 16. Moreover, in the illustrated embodiment, each rib 30, 32, 34 includes curved transitions leading to the ribs to avoid sharp corners and thereby reduce areas of high stress in the pin 16. Moreover, it should be noted that the cavity 26 has a greater height/radial extent at positions adjacent to the ovalarity-resisting ribs 32, as compared to positions adjacent to the stiffening rib 30, to provide further weight reduction to the pin 16, since bending moments and internal stresses may be lesser at the axially-outer portions of the pin 16 adjacent to the ovalarity-resisting ribs 32.

In the embodiment shown in FIGS. 2-4, the pin 16 is formed from a single, unitary or integral, one-piece and seamless piece of material wherein the ribs 30, 32, 34 are unitary with the rest of the pin 16. For example, in one embodiment, the pin 16 is machined from a single solid cylindrical billet of material, such as vacuum re-melted steel or other high quality steel. Alternately, rather than machining, the pin 16 can be formed by various other methods, such as casting, including a lost wax casting (or investment casting) process. The pin 16 can be made from any of a wide variety of materials as desired including, but not limited to, steel (particularly steel with titanium) or carbon fiber materials.

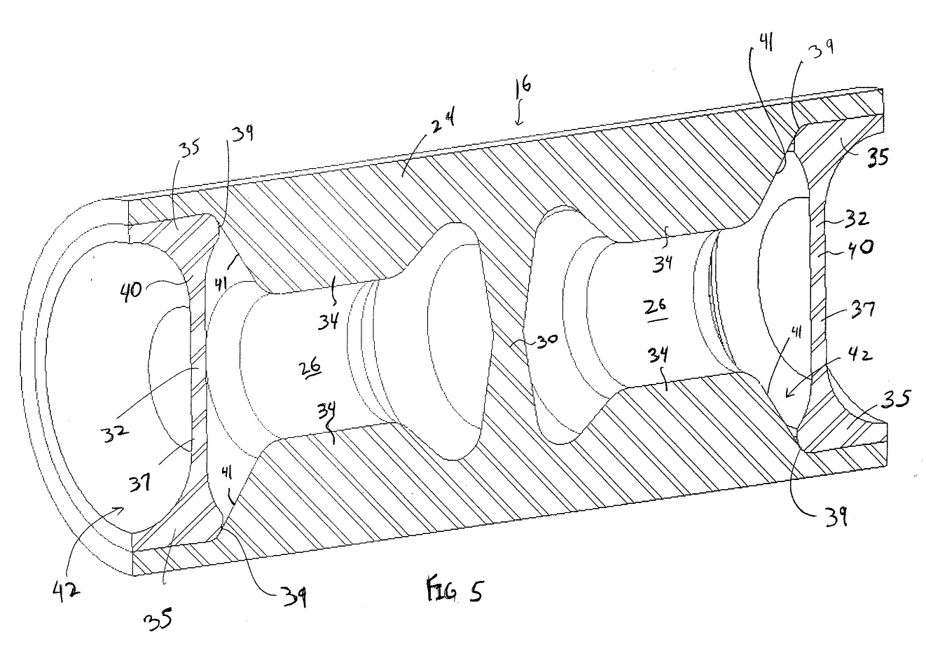

If desired, one or more of the ribs 30, 32, 34 may be made separately from the remainder of the pin 16/pin body 24 in the form of an insert that is inserted in and coupled to the pin 16. For example, as shown in FIG. 5, the pin 16 may include a pin body 24 with an integrally formed stiffening rib 30 and integrally formed shear-resisting ribs 34. The pin body 24 of FIG. 5 (and other embodiments below) may be formed using the methods described above for the pin body 24 shown in FIGS. 2-4.

A pair of opposed inserts 40, in the form of generally disk-shaped components, may be inserted into the inner cavity 26. The inserts 40 take the form of, or provide, the ovalarity-resisting ribs 32. The inserts 40 may be retained in place by any of a variety of methods, such as welding, mechanical and/or thermal fitting (such as being thermally and mechanically fit in place) by the use of a protrusion (i.e., semi-circular protrusion) on one component (either the insert 40 or pin body 24) that fits in a groove of the other component, threaded connections, or other well-known joining methods for fixedly and permanently coupling the inserts 40 to the pin body 24. In one embodiment, each insert 40 has a slight taper (i.e. of about 1-2 degrees in one case) such that each insert 40 increases in height (i.e. in the radial dimension) towards the axial center of the pin 16 to provide an interference fit between each insert 40 and the pin body 24.

In the illustrated embodiment, each insert 40 is shaped somewhat like an I-beam, having a pair of axially-extending flanges 35 connected by a radially-extending center web 37. This configuration provides increased surface area along the outer edges of the flanges 35 to ensure a good connection with the pin body 24. In the illustrated embodiment, the flanges 35 extend axially outwardly to the radial ends of the pin body 24 such that the axial ends of the flanges 35 and the pin body 24 are flush/aligned. Moreover, in the illustrated embodiment the center webs 37 of the inserts 40 are spaced a bit axially-inwardly from the axial ends to aid the shear-resisting ribs 34 and to help the pin 16 resist bending.

The axially-inner ends 39 of each insert 40 abut against a radially-inwardly extending wall 41 of the cavity 26 to limit the axial travel of the insert 40 and ensure the inserts 40 are maintained in the proper position during assembly, and during operation of the engine. Alternately, nearly any radially-inwardly extending portion of the pin body cavity 26 may be utilized as, in place of, the wall 41 to properly locate the inserts 40.

The embodiment of FIG. 5 may provide improved ease of manufacture compared to the embodiment of FIGS. 2-4. In particular, the cavities 26 defining the stiffening rib 30 and shear-resisting ribs 34 are easier to form since they open to a relatively wide mouth 42 at each axial end thereof. Since the pin body 24 may be made of a particularly hard material, any aids to machining of the pin body 24 can be useful. In addition, the embodiment of FIG. 5 also allows the ovalarity-resisting ribs 32 to be complete (and therefore stronger) ribs that extend to the radial center of the pin body 16. In contrast, in the embodiment of FIGS. 2-4, the ovalarity-resisting ribs 32 may be required to have an end opening 44 formed therein to allow the pin 16 to be formed to the desired shape.

However, care must be taken when an insert (such as insert 40) provides any of the ribs 30, 32, 34, as it is possible that any ovalarity induced into the pin body 16 may cause gaps around the circumferential junction between the insert 40 (or other inserts) and the pin body 16. If care is not taken in the design and assembly of the pins/inserts, these gaps may then allow the ovalarity of the pin body 24 to increase. Strongly joining the insert, around its entire circumference, to the pin body 24 helps to minimize the chances of separation between the insert and pin body 24.

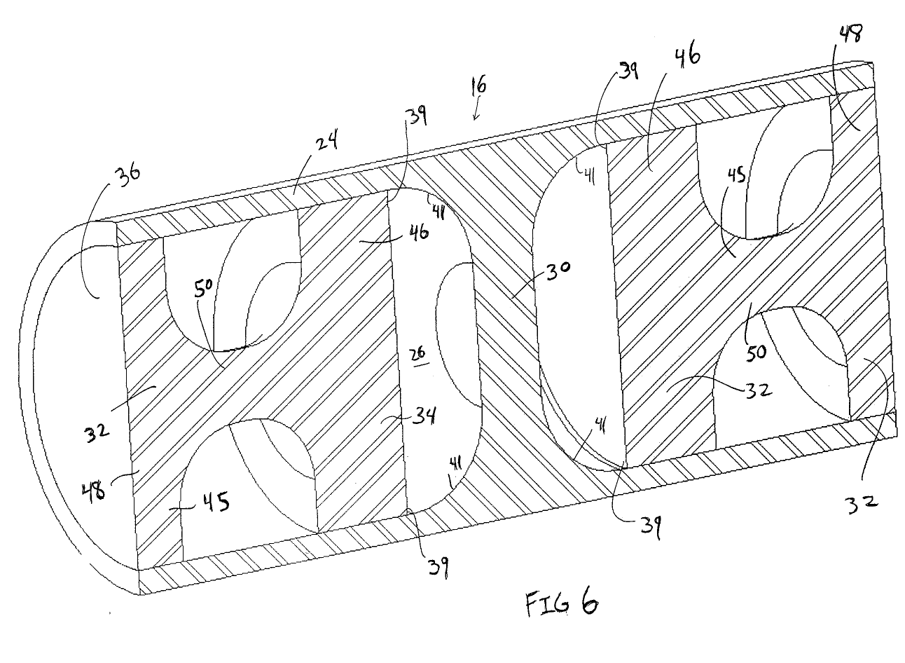

FIG. 6 illustrates another embodiment in which the stiffening rib 30 is integrally formed with the pin body 24, and a pair of inserts 45 provide the ovalarity-resisting ribs 32 and shear-resisting ribs 34. Each insert 45 has a pair of opposed radially-extending webs 46, 48 connected by a center axially-extending web 50. The inner webs 46 provide, or act as, the shear-resisting ribs 34, and the outer webs 48 provide, or act as, the ovalarity-resisting ribs 32. This embodiment may provide further ease of manufacture in that a pair of straight opposed cavities 26 (or sub-cavities) need only be machined into the pin body 24, leaving the center stiffening rib 30. Moreover, in this embodiment each rib 30, 32, 34 is a complete rib to provide increased strength. The axially-inner ends 39 of each insert 45 about against a radially-inwardly extending wall 41 of the cavity 26 to limit axial travel of the inserts 45 in a similar manner to the inserts 40 of FIG. 5 described above.

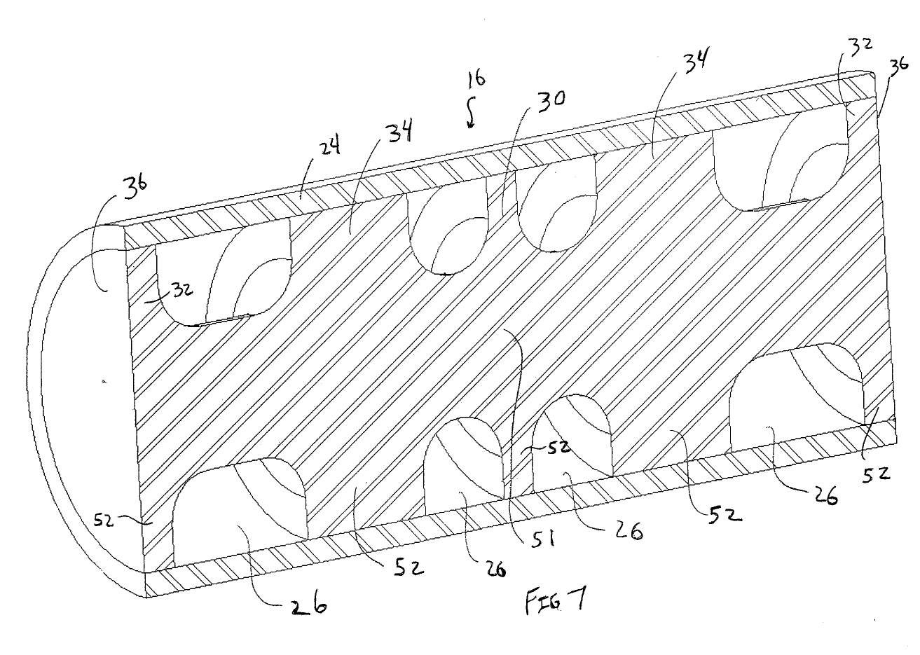

The embodiment shown in FIG. 7 illustrates yet another embodiment in which the pin body 24 is a generally hollow cylinder having a generally cylindrical cavity 26 formed completely therethrough. A single insert 50 with a single, central web 51 and various radially-extending webs 52 is utilized which provides the stiffening rib 30, the pair of ovalarity-resisting ribs 32, and the pair of shear-resisting ribs 34. This embodiment provides further ease of manufacture in that a pin body 24 with a single bore 26 formed all the way through may be provided, which is more easily manufactured than the other pin bodies 24 described and shown above. Moreover, each rib 30, 32, 34 a complete rib to provide increased strength. However, since all of the ribs 30, 32, 34 are provided by the insert 50, care must be taken, as noted above, to minimize separation or circumferential gaps between the insert 50 and the pin body 24.

All the inserts 40, 45, 50 disclosed herein may be made of the same material as the associated pin body 24, or may be made of different material including, but not limited to, steel, including steel/titanium or steel/aluminum, and may include a coating such as a diamond-like carbon coating to reduce fretting. In addition, it should be understood that the inserts 40, 45, 50 shown in FIGS. 5-7 may be broken into one or more component parts with each “sub-insert” providing one or more, or part of one or more, rib, as desired. Moreover, it should be understood that, although each of the inserts 40, 45, 50 in the embodiments of FIGS. 5-7 are illustrated as providing full ribs, each insert 40, 45, 50 may provide either full and/or partial ribs. Moreover, the ribs that are integral with the pin body 26 may also be full or partial ribs, as desired.

The stiffening rib 30 may primary help to resist bending force, the ovalarity-resisting ribs 32 may primarily help to resist ovalarity-resisting loads, and the shear-resisting ribs 34 may primarily help to resist shear loads. However, each of the ribs 30, 32, 34 may help to provide increased strength and resistance to bending, ovalarity, and shear forces, while the cavity 26 helps to reduce weight and improve performance.

Although the invention is shown and described with respect to certain embodiments, it should be clear that modifications will occur to those skilled in the art upon reading and understanding the specification, and the present invention includes all such modifications. Having described the invention in detail and by reference to the various embodiments, it should be understood that modifications and variations thereof are possible without departing from the scope of the invention.

What is claimed is:

1. A pin assembly comprising a piston pin configured to couple a piston to a connecting rod comprising:
a pin body having an inner cavity;
a stiffening rib positioned to resist forces applied to said pin body by a connecting rod;
a pair of ovalarity-resisting ribs;
a pair of shear-resisting ribs, each shear-resisting rib being axially positioned between one of said ovalarity-resisting ribs and said stiffening rib and positioned to resist shear forces applied to said pin body by a connecting rod and a piston; and
at least one insert received in said inner cavity, wherein said at least one insert provides at least one of said stiffening rib, or at least one of said ovalarity-resisting ribs, or at least one of said shear-resisting ribs.

2. The pin assembly of claim 1 wherein said pin body is generally hollow and has an inner cavity, and wherein said stiffening rib, said ovalarity-resisting ribs and said pair of shear resisting ribs are positioned in said inner cavity.

3. The pin assembly of claim 1 wherein said pin body has a generally cylindrical outer surface.

4. The pin assembly of claim 1 wherein each shear-resisting rib is positioned to resist the greatest shear forces applied by said connecting rod and said piston to said pin body.

5. The pin assembly of claim 1 wherein said at least one insert is made of a separate piece of material than said pin body and is closely received in said inner cavity.

6. The pin assembly of claim 1 wherein both of said ovalarity-resisting ribs are full ribs which are generally circular in end view.

7. The pin assembly of claim 1 wherein said stiffening rib is positioned at an axial center of said pin body, and wherein said pair of ovalarity-resisting ribs are positioned at or adjacent to opposite axial ends of said pin.

8. The pin assembly of claim 1 wherein said pin body, said stiffening rib and said pair of shear-resisting ribs are made from a single, unitary piece of material, and said at least one insert includes one of said ovalarity-resisting ribs, and wherein the pin assembly further includes a supplemental insert received in said inner cavity, wherein said supplemental insert provides the other one of said ovalarity-resisting ribs.

9. The pin assembly of claim 1 wherein said pin body and said stiffening rib are made from a single, unitary piece of material, and said at least one insert includes one of said ovalarity-resisting ribs and one of said shear-resisting ribs, and wherein the pin assembly includes a supplemental insert received in said inner cavity, wherein said supplemental insert provides the other one of said ovalarity-resisting ribs and the other one of said shear-resisting ribs.

10. The pin assembly of claim 1 wherein said at least one insert provides said stiffening rib, said pair of said ovalarity-resisting ribs, and said pair of said shear-resisting ribs.

11. The pin assembly of claim 1 wherein said stiffening rib and said ovalarity-resisting ribs are full ribs that extend to a radial center of said pin body, and wherein said shear resisting ribs are partial ribs that do not extend to said radial center of said pin body.

12. The pin assembly of claim 1 wherein said stiffening rib, said ovalarity-resisting ribs, and said shear resisting ribs are full ribs that extend to a radial center of said pin body.

13. The pin assembly of claim 1 wherein said pin body includes a radially inwardly extending portion, and wherein said at least one insert abuts against said radially inwardly extending portion such that said radially inwardly extending portion limits axial travel of said at least one insert relative to said pin body.

14. The pin assembly of claim 1 further comprising a connecting rod and a piston that is reciprocable in a direction generally perpendicular to an axis of said piston pin, and wherein said piston pin couples said piston to said connecting rod such that said reciprocal motion of said piston is transferred to said connecting rod.

15. A pin assembly comprising:
a pin body having an inner cavity;
a stiffening rib;
a pair of ovalarity-resisting ribs; and
a pair of shear-resisting ribs, each shear-resisting rib being axially positioned between one of said ovalarity-resisting ribs and said stiffening rib, wherein the pin assembly includes at least one insert received in said inner cavity, wherein said at least one insert provides at least one of said stiffening rib, or at least one of said ovalarity-resisting ribs, or at least one of said shear-resisting ribs.

16. A method for making pin assembly comprising:
providing a pin body having an inner cavity;
providing at least one insert; and
inserting said insert into said inner cavity to form said pin assembly, wherein said pin assembly includes a stiffening rib positioned to resist forces applied to said pin body by a connecting rod, a pair of ovalarity-resisting ribs, and a pair of shear-resisting ribs, each shear-resisting rib being axially positioned between one of said ovalarity-resisting ribs and said stiffening rib and being positioned to resist shear forces applied to said pin body by a connecting rod and a piston, and wherein said at least one insert provides at least one of said stiffening rib, or at least one of said ovalarity-resisting ribs, or at least one of said shear-resisting ribs.

17. A pin assembly comprising a piston pin configured to couple a piston to a connecting rod comprising:
a pin body;
a stiffening rib positioned to resist forces applied to said pin body by a connecting rod;
a pair of ovalarity-resisting ribs positioned at or adjacent to opposite axial ends of said pin, each ovalarity-resisting rib extending to a radial center of said pin body; and
a pair of shear-resisting ribs, each shear-resisting rib being axially positioned between one of said ovalarity-resisting ribs.

18. The pin assembly of claim 17 wherein said pin body includes an inner cavity, and wherein the pin assembly further includes at least one insert received in said inner cavity, wherein said at least one insert provides at least one of said stiffening rib, or at least one of said ovalarity-resisting ribs, or at least one of said shear-resisting ribs.

19. A pin assembly comprising a piston pin configured to couple a piston to a connecting rod comprising:
a pin body;
a stiffening rib positioned to resist forces applied to said pin body by a connecting rod, said stiffening rib extending to a radial center of said pin body;
a pair of ovalarity-resisting ribs positioned at or adjacent to opposite axial ends of said pin; and
a pair of shear-resisting ribs, each shear-resisting rib being axially positioned between one of said ovalarity-resisting ribs and said stiffening rib and positioned to resist shear forces applied to said pin body by a connecting rod and a piston.

20. The pin assembly of claim 19 wherein said stiffening rib is positioned at an axial center of said pin body, and wherein said pin body is generally hollow and has an inner cavity, and wherein said stiffening rib, said ovalarity-resisting ribs and said pair of shear resisting ribs are positioned in said inner cavity.

21. The pin assembly of claim 19 wherein said stiffening rib and said ovalarity-resisting ribs are full ribs that extend to a radial center of said pin body, and wherein said shear-resisting ribs are partial ribs that do not extend to said radial center of said pin body.

22. The pin assembly of claim 19 wherein said pin body, said stiffening rib, said pair of ovalarity-resisting ribs, and said pair of shear-resisting ribs are all made of a single, unitary piece of material.

23. The pin assembly of claim 19 wherein said pin body is made from a first piece of material, and wherein at least one of said stiffening rib, or one of said ovalarity-resisting ribs, or one of said shear-resisting ribs are made of a second piece of material received in said first piece of material.

24. The pin assembly of claim 19 wherein said pin body, said stiffening rib, and said pair of shear-resisting ribs are made from said first piece of material, and one of said ovalarity-resisting ribs is made of a second piece of material received in said first piece of material, and the other one of said ovalarity-resisting ribs is made of a third piece of material received in said first piece of material.

25. The pin assembly of claim 19 wherein each ovalarity-resisting rib is positioned at or adjacent to opposite axial ends of said pin.

26. The pin assembly of claim 19 wherein said pin body and said stiffening rib are made from a first piece of material, and wherein one of said ovalarity-resisting ribs and one of said shear-resisting ribs are made of a second piece of material received in said first piece of material, and wherein the other one of said ovalarity-resisting ribs and the other one of said shear-resisting ribs are made of a third piece of material received in said first piece of material.

27. The pin assembly of claim 19 wherein said pin body is made from a first piece of material, and wherein said stiffening rib, said pair of said ovalarity-resisting ribs, and said pair of said shear-resisting ribs are made of a second piece of material received in said first piece of material.

28. The pin assembly of claim 19 further comprising a connecting rod and a piston that is reciprocable in a direction generally perpendicular to an axis of said piston pin, and wherein said piston pin couples said piston to said connecting rod such that said reciprocal motion of said piston is transferred to said connecting rod.
